(19) United States
(12) Patent Application Publication
(10) Pub. No.: US 2025/0215687 A1
(43) Pub. Date: Jul. 3, 2025

(54) REFLECTIVE ROOFING MATERIAL

(71) Applicant: Garland Industries, Inc., Independence, OH (US)

(72) Inventors: Julie Anne Geyer, Brecksville, OH (US); Elizabeth C. Massien, Westlake, OH (US)

(21) Appl. No.: 18/946,708

(22) Filed: Nov. 13, 2024

Related U.S. Application Data
(60) Provisional application No. 63/615,971, filed on Dec. 29, 2023.

(51) Int. Cl. E04D 5/10; B32B 7/12; B32B 11/02; B32B 11/04; B32B 27/30

(52) U.S. Cl. CPC E04D 5/10; B32B 7/12; B32B 11/02; B32B 11/046; B32B 27/304; B32B 2250/02; B32B 2307/416; B32B 2307/7376; B32B 2419/06

(57) ABSTRACT

A roofing and/or siding material having a resulting reflectivity of at least about 50%. The roofing and/or siding material includes a modified bitumen sheet/membrane, a fiber reinforcement layer and a reflective polymer layer material. The reflective polymer layer material includes polyvinyl fluoride.

### REFERENCED APPLICATIONS

The present disclosure claims priority on U.S. Provisional Patent Application Ser. No. 63/615,971 filed Dec. 29, 2023, which is fully incorporated herein by reference.

### FIELD OF DISCLOSURE

The present disclosure is directed to roofing and/or siding materials, and more particularly to improved roofing and/or siding materials having improved reflectivity.

### BACKGROUND OF THE DISCLOSURE

In North America, asphalt-modified bitumen roofing materials are a popular medium for covering roofs of homes and other structures. Asphalt-modified bitumen roofing materials typically come in shingle or roll form, the shingle being the more widely used material. A typical asphalt shingle has an asphalt substrate and a multitude of granules placed thereon.

As energy prices have risen, the demand for energy efficient roof systems has increased. In certain communities, building codes have been issued to require more energy efficient buildings. Energy-efficient roofing materials can result in cooler roof surfaces and less energy spent to cool a building. As such, energy-efficient roofing materials can reduce building cooling costs. The use of energy efficient roof coatings can also reduce the amount of roof insulation required in a building.

Due to the demand of energy-efficient roofing materials, several roofing systems have been developed. One type of energy-efficient roofing material is disclosed in U.S. Pat. No. 6,933,007 discloses the use of reflective granules on a roofing material to form energy-efficient roofing materials, which is incorporated herein by reference. U.S. Pat. No. 8,277,882, which is incorporated herein by reference, discloses a paint applied to a roofing material to form energy-efficient roofing materials.

Various types of acrylic coatings have been used on roofing materials to form energy-efficient roofing materials. For example, white, water-modified bitumen acrylic coatings have been found to provide the highest reflectivity and longevity. White reflective coatings also typically minimize heat damage to roof membranes, increasing their expected service lives. Acrylic coatings primarily are formulated with pigments, acrylic polymers and water. There may be other additives, such as fibers for reinforcement, glycol for freeze thaw resistance, intumescent or other fire-retardant additives, or biocides to prevent fungal growth in the container. Historically, prior art white, water-modified bitumen acrylic coatings have problems maintaining roof surface reflectivity. For instance, reflectivity can decrease significantly during the first year of a roof's life. Changes in reflectivity are related to changes with the coating itself (e.g., coating-erosion or cracking) and/or accumulation of particulate matter (e.g., dirt) from the environment.

Some prior art acrylic coatings have been applied directly to granule-surfaced modified bitumen roof membranes on new roof systems. Granules are difficult to coat because of their rough, uneven surface areas. Moisture and air pockets can be trapped under the acrylic coating and lead to blisters or pinholes in the cured acrylic coating. As such, inconsistent coverage and potential cracking of areas where the coating is applied too heavily are additional problems related to application of previous acrylic coatings.

Another type of energy-efficient roofing material is disclosed in U.S. Pat. No. 8,216,681, which is incorporated herein by reference, discloses a roofing material includes one or more layers of PVDF (polyvinyladine fluoride). In spite of their fantastic weatherability, abrasion resistance, and thermal stability, PVDF films tend to not have sufficient elasticity on their own and therefore need to contain additional layers of more flexible polymers, adding additional processing steps and cost to the final product.

Although the color of a particular roofing system plays an important role in determining which roofing system will be purchased by consumers, other factors are also of importance in determining the color of a particular roofing system. One such factor is the energy efficiency of the roofing system. Several cities and states are beginning to consider legislation or currently require some roofing structures to have a certain resulting reflectivity. This is of particular importance in temperate regions, such as in the Southern and Southwest regions of the United States. Lighter colored roofs are known to reduce the roof temperature, thereby reducing the cooling costs of the roofed structure. The cooler temperature of the light-colored roof system not only reduces the cooling costs associated with the building, but the heat generated by the light-colored roof contributes less heat to the surrounding environment, thus improving air quality, especially in urban areas.

Typical light colored roofing systems have light colored granules having a reflectivity of up to 30% and a resulting roofing reflectivity of up to 27%. Darker colored granules typically have a lower reflectivity and a resulting roofing reflectivity that is less than roofing systems having lighter colored granules. The bitumen layer on the roofing system is a generally black color, thus has a low reflectivity. When coating the bitumen layer with lighter colored or reflective particles, some of the bitumen surface remains exposed, thus reducing the resulting reflectivity of the roofing system.

One practice for obtaining a highly reflective surface on a roofing system is to apply a thick coating of highly reflective white paint to the surface of the installed roofing system. Typically, a wet paint coating thickness of about 5 dry mils or more was applied after the roofing system is installed on a structure. The application of a highly reflective paint layer on the existing roof system can be used to achieve a resulting solar reflectivity of 70% or greater. Common white colored paints include titanium dioxide (TiO₂) as the primary pigment component. Because of TiO₂ unparalleled hiding properties and white pigment properties, finding a suitable a substitute among the available pigments and extenders that are still considered non-hazardous has been difficult without creating a negative effect on the solar reflectance, thermal emittance, and Solar Reflective Index (SRI) of the coating. Also, care needs to be taken to find the right pigment volume concentration that will not take away from the long-term properties that these roof coatings need to possess for the exterior environmental conditions that the coating will be exposed.

In view of the current state of the art there is a continuing need for new and improved reflective film that may be applied in-plant during manufacture of the roofing/siding membrane. In particular, a reflective film is needed that is reflective, energy efficient, as well as flexible, durable and easy to apply.

Prior art references that are incorporated herein by reference are U.S. Pat. Nos. 2,379,358; 3,255,031; 3,479,201; 3,528,842; 4,039,706; 4,120.132; 4,288,959; 4,342,804; 4,478,869; 5,088,259; 5,132,164; 5,456,785; 5,474,838; 5,540,971; 5,643,399; 5,573,810; 5,695,373; 5,813,176; 5,965,626; 6,110,846; 6,194,519; 6,207,593; 6,296,912; 6,296,921; 6,341,462; 6,360,511; 6,502,360; 6,933,007; 7,070,844; 7,803,725; 8,216,681; 8,277,882; 9,499,986; 10,626,615; 10,597,555; 11,046,613; 11,433,366; 11,136,760; 11,427,507; 11,371,244; and 11,453,614; and US Patent Publication Nos. 2004/0071938; 2005/0145139; 2005/0250399; 2005/0261407; 2005/0257875; 2005/0261409; 2007/0054129; 2009/0053529 and 2012/0266553.

Several of these references illustrate various types roof membranes and particles applied to the roof membranes.

### SUMMARY OF THE DISCLOSURE

The present disclosure relates to roofing and/or siding materials and a method of making such materials having improved reflectivity. The present disclosure is applicable to many types of roofing and/or siding materials including, but not limited to, shingles, cap sheet roll roofing, modified bitumen, metal roofing and/or siding, plastic roofing and/or siding, and wood roofing and/or siding. The present disclosure is particularly applicable to prefabricated roofing systems such as, but not limited to, shingles, cap sheet roll roofing, modified bitumen, metal roofing and/or siding, plastic roofing and/or siding, and wood roofing and/or siding wherein the roofing materials are manufactured off site and then subsequently installed on a roof and/or siding of a building or other type of structure.

In one non-limiting aspect of the present disclosure, the roofing and/or siding system includes a modified bitumen sheet/membrane; a reflective polymer layer material, and an optional fiber reinforcement layer. The roofing and/or siding system has a) a resulting reflectivity of at least about 50% as determined by the test methods in accordance with one or more of ASTM C1549-16; ASTM E903 (spectrometer); ASTM C1549 (reflectometer); ASTM E1918 (pyranometer); and ASTM E892; and/or b) a Solar Reflectance Index (SRI) of at least 50 in accordance with ASTM E1980. In one non-limiting embodiment, the roofing and/or siding system that has a) a resulting reflectivity of 50%-99% (and all values and ranges therebetween) as determined by the test methods in accordance with one or more of ASTM C1549-16; ASTM E903 (spectrometer); ASTM C1549 (reflectometer); ASTM E1918 (pyranometer); and ASTM E892; and/or b) a Solar Reflectance Index (SRI) of 50%-99% (and all values and ranges therebetween) in accordance with ASTM E1980. The improved reflectivity of the roofing and/or siding system provides several benefits to the roofing and/or siding system, namely a) reduces the temperature of the surface of the roofing and/or siding system, especially on warm, sunny days, b) reduces the amount of heat transfer from the surface of the roofing and/or siding system to the structure positioned adjacently the roofing and/or siding system, c) reduces the contribution of the roofing and/or siding system as an urban heat island, which can have negative effect on air quality in urban areas, c) increases the life of the roofing and/or siding system, and/or f) reduces the amount of sunlight that penetrates into the surface of the roofing and/or siding system, thus enabling the roofing system to be classified as a “cool roof”. Resulting reflectivity or solar reflectance is defined as the fraction of solar flux reflected by a surface expressed as a percent from 0-100%. The improved reflectivity of the roofing and/or siding system provides several benefits to the roofing and/or siding system. The increased resulting reflectivity of the roofing and/or siding system reduces the temperature of the surface of the roofing and/or siding system, especially on warm, sunny days. The reduced surface temperature of the roofing and/or siding system reduces the amount of heat transfer from the surface of the roofing and/or siding system to the structure positioned adjacent the roofing and/or siding system. As a result, less energy is required to maintain the structure adjacent the roofing and/or siding system at a cooler temperature. The reduced surface temperature of the roofing and/or siding system also reduces the contribution of the roofing and/or siding system as an urban heat island, which can have negative effect on air quality in urban areas. As a result, the improved roofing and/or siding system is more environmentally friendly. The increased reflectivity of the roofing and/or siding system also increases the life of the roofing and/or siding system. Increased roof temperatures result in the increased rate of degradation to the materials that make of the roofing and/or siding system (e.g., bitumen, modified bitumen, asphalt, woven materials, nonwoven materials, adhesives, etc.). In addition to the adverse effects of high temperatures, sunlight, especially UV light, can increase the rate of degradation of the materials that make up the roofing and/or siding system. The improved reflectivity of the roofing and/or siding system of the present disclosure can increase the life of the roofing and/or siding system by reducing the surface temperature of the roofing and/or siding system, thus reducing the rate of thermal degradation. The improved reflectivity of the roofing and/or siding system of the present disclosure also can increase the life of the roofing and/or siding system by reducing the amount of sunlight that penetrates into the surface of the roofing and/or siding system. The improved reflectivity of the roofing and/or siding system of the present disclosure can also enable the roofing system to be classified as a “cool roof.” Such a roofing classification can provide many advantages for buildings such as, but not limited to, tax incentives, relaxation of various envelope criteria of a building with respect to energy classifications, etc. The roofing membrane with the present invention can be designed to meet building codes for solar reflectance (e.g., International Codes Council (ICC), California Energy Commission (CEC) Title 24, etc.).

### Reflective Polymer Layer Material

In a non-limiting aspect of the present disclosure, a novel reflective polymer layer material is applied to a roofing and/or siding system to significantly increase the reflectivity of the roofing and/or siding system. The novel reflective polymer layer material is generally a light colored material such as, but not limited to a white or generally white colored material (e.g., Pantone 11-0601, Pantone 11-4001, Pantone 11-4801, Pantone 11-0607, Pantone 11-0608, Pantone 11-0507, Pantone 11-0602, Pantone 11-0105, Pantone 11-0701, Pantone 11-4302, Pantone 11-4202, Pantone 11-4301, Pantone 11-1302, Pantone 11-0110, Pantone 12-0000, Pantone 12-0104, etc.). In accordance with the present disclosure, the novel reflective polymer layer material provides energy efficacy, high reflectivity, durability, to the roofing and/or siding system and is easy to apply to various types of roofing and/or siding systems. In one non-limiting embodiment of the disclosure, the reflectivity provided by the reflective polymer layer material can be designed to meet building codes for solar reflectance, e.g. International Codes Council (ICC), California Energy Commission (CEC) Title 24, etc. In one non-limiting embodiment, the reflective polymer layer material has a) a resulting reflectivity of at least about 50% as determined by the test methods in accordance with one or more of ASTM C1549-16; ASTM E903 (spectrometer); ASTM C1549 (reflectometer); ASTM E1918 (pyranometer); and ASTM E892; and/or b) a Solar Reflectance Index (SRI) of at least 50 in accordance with ASTM E1980. In one non-limiting embodiment, the reflective polymer layer material that has a) a resulting reflectivity of 50%-99% (and all values and ranges therebetween) as determined by the test methods in accordance with one or more of ASTM C1549-16; ASTM E903 (spectrometer); ASTM C1549 (reflectometer); ASTM E1918 (pyranometer); and ASTM E892; and/or b) a Solar Reflectance Index (SRI) of 50%-99% (and all values and ranges therebetween) in accordance with ASTM E1980. In another non-limiting embodiment, the reflective polymer layer material that has a) a resulting reflectivity of 60%-99% as determined by the test methods in accordance with one or more of ASTM C1549-16; ASTM E903 (spectrometer); ASTM C1549 (reflectometer); ASTM E1918 (pyranometer); and ASTM E892; and/or b) a Solar Reflectance Index (SRI) of 50%-99% (and all values and ranges therebetween) in accordance with ASTM E1980. In another non-limiting embodiment, the reflective polymer layer material that has a) a resulting reflectivity of 70%-99% as determined by the test methods in accordance with one or more of ASTM C1549-16; ASTM E903 (spectrometer); ASTM C1549 (reflectometer); ASTM E1918 (pyranometer); and ASTM E892; and/or b) a Solar Reflectance Index (SRI) of 50%-99% (and all values and ranges therebetween) in accordance with ASTM E1980.

In another and/or alternative non-limiting embodiment of the disclosure, the reflective polymer layer material can be secured directly or indirectly to various roof and/or siding substrates (e.g., modified bitumen membranes [i.e., SBS membranes, APP membranes, SEBS membranes, SBR membranes, coal tar membranes, etc.], asphalt membranes, metal surfaces, plastic surfaces, wood surfaces, etc.). As such non-limiting embodiment, the polymer layer material is a preformed layer that is applied various roof and/or siding substrates. The preformed polymer layer material can be secured to the various roof and/or siding substrates by various arrangements (e.g., adhesive, lamination, melted connection, use of a fleece backing material, hook and loop fasteners, mushroom fasteners, mechanical connections [e.g., staples, sewing, rivets, clamps, etc.], etc.). As can be appreciated, the polymer layer material can be coated on the various roof and/or siding substrates (e.g., dip coating, spray coating, roller coating, brush coating, etc.). When the polymer layer material is coated on the various roof and/or siding substrates, the top surface of the various roof and/or siding substrates to be coated with the polymer layer material can optionally include a woven and/or non-woven material used to facilitate in securing the polymer layer material to the various roof and/or siding substrates. In another non-limiting embodiment of the disclosure, the reflective polymer layer material is or includes one or more layers of polyvinyl fluoride (PVF) (e.g., Tedlar™ from DuPont). In one specific arrangement, the thickness of the one or more layers of polyvinyl fluoride (PVF) is at least 0.5 mils (e.g., 0.5-200 mils and all values and ranges therebetween). In another specific arrangement, the thickness of the one or more layers of polyvinyl fluoride (PVF) is about 2-10 mils. In another and/or alternative non-limiting aspect of the present disclosure, the reflective polymer layer material has a thickness that is generally thinner than the thickness of the modified bitumen sheet/membrane. Generally, the thickness ratio of the modified bitumen sheet/membrane to the reflective polymer layer material is generally at least about 1.5:1 (e.g., 1.5:1 to 300:1 and all values and ranges therebetween), typically at least about 2:1, more typically about 2:1 to 250:1, and even more typically about 2:1 to 100:1; however, other thickness ratios can be used. The thickness of the reflective polymer layer material is generally at least about 0.5 mil (0.0005 inch.) (e.g., 0.5-100 mils and all values and ranges therebetween), typically 1-20 mils, and more typically 2-5 mils.

In another and/or alternative non-limiting aspect of the present disclosure, the reflective polymer layer material is at least partially secured to the top surface of a modified bitumen sheet/membrane via a) an adhesive layer between the reflective polymer layer material and the top surface of the modified bitumen sheet/membrane, and/or b) a fleece layer between the reflective polymer layer material and the top surface of the modified bitumen sheet/membrane. In one non-limiting embodiment, the reflective polymer layer material is a preformed layer that is partially or fully secured to a top surface of the modified bitumen sheet/membrane by use of an adhesive. The adhesive can be 1) applied to the top surface of the modified bitumen sheet/membrane, 2) applied to the bottom side of the reflective polymer layer material, and/or 3) applied to the optional fleece layer. The type of adhesive is non-limiting. The application process for applying the adhesive is non-limiting (e.g., spray coating, dip coating, brush/roller applied, etc.). In one specific arrangement, the adhesive is a thermoplastic acrylic adhesive, polyurethane adhesive, resin adhesive, epoxy adhesive, polyimide adhesive, hot melt adhesive, cyanoacrylate ester adhesive, etc. The thickness of the adhesive layer, when used, is non-limiting. In one non-limiting arrangement, the adhesive layer is at least 0.01 mils (e.g., 0.01-50 mills and all values and ranges therebetween), and typically 0.5-5 mills. In another non-limiting embodiment, the adhesive layer is applied to the top surface of the modified bitumen sheet/membrane and/or the bottom side of the reflective polymer layer material, and thereafter the reflective polymer layer is mated with the modified bitumen sheet/membrane and the adhesive layer secures the reflective polymer layer to the modified bitumen sheet/membrane. In another non-limiting embodiment, when a fleece layer is used, a portion of the fleece layer is connected to a bottom surface of the reflective polymer layer material (e.g., fleece at least partially embedded in the bottom surface of the reflective polymer layer material, and/or fleece adhesively connected to the bottom surface of the reflective polymer layer material, etc.), and a portion of the fleece layer is connected to a top surface of the modified bitumen sheet/membrane (e.g., fleece at least partially embedded in the top surface of the modified bitumen sheet/membrane, and/or fleece adhesively connected to the top surface of the modified bitumen sheet/membrane, etc.). The thickness and material of the fleece, when used, is non-limiting. In one non-limiting arrangement, the fleece layer is at least 0.1 mils (e.g., 0.1-100 mills and all values and ranges therebetween), and typically 1-55 mills. The composition of the fleece layer can include glass fibers, carbon fibers, and/or polymeric fibers (e.g., polyester, polyethylene, fiber glass reinforced polyester, nylon, aramid fibers, polypropylene, polyacrylonitrile, polyurethanes, etc.). The fleece layer can be woven and/or non-woven.

### Modified Bitumen Sheet/Membrane

The modified bitumen sheet/membrane can be in the form of roofing and/or siding shingles, cap sheet roll roofing and/or siding, modified bitumen materials, or metal, plastic and wood roofing and/or siding.

Roofing systems having a bitumen- or asphalt-modified bitumen water-resistant layer such as, but not limited to, roofing and/or siding shingles, cap sheet roll roofing and/or siding, and modified bitumen materials, are well-known. Due to their chemical composition, these water-resistant layers are highly absorptive of radiation. In fact, these roofing layers may be regarded in an uncoated state as black-body absorbers; that is, they effectively absorb almost all of the radiation that impinges upon them. Such surfaces absorb radiation, thereby resulting in increased temperature which can result in thermal degradation of the roofing system and/or increase the cooling costs of the roofed structure.

Roofing and/or siding shingles and cap sheet roll roofing and/or siding are commonly formed form of a bituminous compound layer and a fiber reinforcement layer that is coated with the bituminous compound layer. The fiber reinforcement layer can be a nonwoven fabric such as, but not limited to, felt (organic, glass fiber, polyester, polypropylene, etc.), fiberglass, or similar materials, which are commonly coated with a material. As can be appreciated, the fiber reinforcement layer can be a woven fabric material. Non-limiting compositions of the bituminous compound layer that are used on roofing and/or siding shingles and cap sheet roll roofing and/or siding include bitumens, modified bitumens, tars, pitches, asphalt, and the like. As can be appreciated, other types of coatings (e.g., polymers, etc.) can be used as an alternative coating or in conjunction with the bituminous compound layer. A solid material such as, but not limited to, granules can be pressed into the bituminous compound layer while it is in a warm, softened condition; however, this is not required. Finely divided materials such as, but not limited to, ground glass, recycled ground glass, mica flakes, talc, silica dust or the like can be applied and/or made adherent to the non-weather exposed surface of the shingle to prevent sticking of the adjacent layers of the material when placed in packages or shipment or storage; however, this is not required. The bituminous compound layer can include a filler such as, but not limited to, inorganic fillers or mineral stabilizers, organic materials such as polymers, recycled streams, or ground tire rubber, slate flour and/or powdered limestone. As can be appreciated, other materials can be included with the bituminous compound layer (e.g., UV stabilizer, retardant, reinforcement fibers, fire retardant, antimicrobial materials, antioxidant, etc.).

Modified bitumen materials include a bituminous compound layer that may or may not include a fiber reinforcement layer that is at least partially impregnated with the bituminous compound layer. The fiber reinforcement layer typically includes, but is not limited to, a layer of woven or nonwoven material connected to one or more layers of warp and/or weft strands. The layers warp and/or weft strands can optionally be stitched together, knitted together, at least partially melted together or otherwise bound together to maintain the integrity of the fiber reinforcement layer. The fiber reinforcement layer can be optionally coated with a resin or sizing to prevent slippage between the layers of the fiber reinforcement layer and/or to impart a measure of stiffness to the fiber reinforcement layer. The fiber reinforcement layer can be formed of material such as, but not limited to, natural materials, polymeric materials, inorganic materials or combinations thereof. Non-limiting examples of such fibers include polycrystalline fibers, fiberglass, thermoplastic fiber filaments (e.g., polyamide fibers of poly(p-phenylene terephthalate), poly(o-phenylene terephthalamide), ultra-low shrink polyester), cotton, cellulose, natural rubber, flax, ramie, hemp, sisal, wool, linen (flax), paper, wood pulp, polyamides, polyesters, acrylics, polyolefins, polyurethanes, vinyl polymers, and derivatives, or mixtures thereof. The fibers can be continuous filaments, fibers, strands and/or yarn; however, this is not required. The fiber reinforcement layer can be optionally coated with the bituminous compound layer. Non-limiting compositions of the bituminous compound layer that are used on roofing and/or siding shingles and cap sheet roll roofing and/or siding include bitumens, modified bitumens, tars, pitches, asphalt, and the like. The bituminous compound layer can include a filler such as, but not limited to, inorganic fillers or mineral stabilizers, organic materials such as polymers, recycled streams, or ground tire rubber, slate flour and/or powdered limestone. As can be appreciated, other materials can be included with the bituminous compound layer (e.g., UV stabilizer, retardant, reinforcement fibers, fire retardant, antimicrobial materials, antioxidant, etc.).

Metal, plastic and wood roofing and/or siding can optionally be coated with solid material such as, but not limited to, granules or slag to provide texture, color and/or improved durability. Typically, the solid material is adhered to the metal, plastic and/or wood roofing and/or siding by the use of an adhesive such as, but not limited to, polymer adhesives, glue, bitumen, asphalt, etc. Non limiting examples of metal, plastic and/or wood roofing and/or siding are disclosed in U.S. Pat. Nos. 4,120,132 and 4,288,959, which are incorporated herein by reference. Due to composition and/or color of the materials, these materials can absorb significant amounts of radiation, thereby resulting in increased temperature which can result in thermal degradation of the roofing system and/or increase the cooling costs of the roofed structure.

In one non-limiting embodiment, the modified bitumen sheet/membrane can be formed of one or more layers. When the modified bitumen sheet/membrane includes two or more layers, an adhesive layer and/or a fiber reinforcement layer can optionally be positioned between two layers of modified bitumen sheet/membrane. The thickness of each layer of the modified bitumen sheet/membrane is generally 5-1500 mils (and all values and ranges therebetween), and typically 5-500 mils, and more typically 10-200 mils.

In another and/or alternative non-limiting embodiment, the modified bitumen sheet/membrane includes a bituminous compound layer. The bitumen compound layer includes a primary hydrocarbon compound (e.g., bitumen or asphalt, coal tar); and optionally one or more of a) filler (e.g., calcium carbonate, chalk, clay, dolomite, kaolin, silica, talc, etc.); b) polymer modifier (e.g., APAO [amorphous polyolefin], APP [atactic polypropylene], EVA [ethylene vinyl acetate], EBA [ethylene butyl acrylate], PPA [polyphthalamide], PPI [polymeric polyisocyanate], PE [polyethylene], PA [polyamide], PP [polypropylene] SEBS [styrene ethylene butadiene styrene], SBS [styrene butadiene styrene], SIS [styrene-isoprene-styrene], thermoplastic urethane [TPU], reactive elastomeric terpolymers [RET], etc.); c) hydrocarbon resin or process oil (e.g., naphthenic oil, paraffinic oil, C5-C9 aromatic hydrocarbon, etc.); d) ground tire rubber; c) antioxidant; f) UV stabilizer; g) fire retardant (e.g., alumina trihydrate, ammonium polyphosphate, melamine poly(zinc phosphate), etc.); h) wax (e.g., paraffin wax, etc.); i) reinforcement fibers (e.g., Kevlar®, carbon fibers, fiberglass, boron fibers, polyethylene fibers, polypropylene fibers, recycled polymer and/or plastic fibers, etc.); and/or j) tackifying agent.

In another and/or alternative non-limiting embodiment, the primary hydrocarbon compound constitutes 25-90 wt. % (and all values and ranges therebetween) of the bitumen compound layer. In one specific formulation, the primary hydrocarbon compound constitutes 25-80 wt. % of the bitumen compound layer. In another specific formulation, the primary hydrocarbon compound constitutes 25-60 wt. % of the bitumen compound layer. In another specific formulation, the primary hydrocarbon compound constitutes 25-50 wt. % of the bitumen compound layer. In another specific formulation, the primary hydrocarbon compound constitutes 25-49 wt. % of the bitumen compound layer. The primary hydrocarbon compound can be fully formed of bitumen, or can be a mixture of bitumen and coal tar. The type of bitumen used in the bitumen compound layer is non-limiting. In one non-limiting example, the bitumen is PG64-22 grade. In another non-limiting example, the bitumen is bitumen penetration grade 40/50. In another non-limiting example, the bitumen is bitumen penetration grade 50/70. In another non-limiting example, the bitumen is bitumen penetration grade 60/70. In another non-limiting example, the bitumen or blend of bitumen (when used) has a softening point about 43.3-121.1° C. (110-250° F.) (and all values and ranges therebetween); and a penetration typically of about 4-80 dmm (and all values and ranges therebetween) at 22.2° C. (75° F.). In one non-limiting embodiment, the primary hydrocarbon compound includes 25-100 wt. % bitumen (and all values and ranges therebetween) and 0-75 wt. % coal tar (and all values and ranges therebetween). In another non-limiting embodiment, the primary hydrocarbon compound includes 60-100 wt. % bitumen and 0-40 wt. % coal tar (and all values and ranges therebetween). In another non-limiting embodiment, the primary hydrocarbon compound includes 25-90 wt. % bitumen and 10-75 wt. % coal tar.

The filler, when included in the bitumen compound layer, constitutes about 0.5-66 wt. % (and all values and ranges therebetween) of the bitumen compound layer. In one non-limiting formulation, the filler (when used) constitutes 0.5-60 wt. % of the bitumen compound layer. In another non-limiting formulation, the filler (when used) constitutes 5-50 wt. % of the bitumen compound layer. In another non-limiting formulation, the filler (when used) constitutes 10-50 wt. % of the bitumen compound layer. In another non-limiting formulation, the filler (when used) constitutes 10-35 wt. % of the bitumen compound layer. In another non-limiting formulation, the filler (when used) constitutes 12-35 wt. % of the bitumen compound layer. In another non-limiting formulation, the weight percent of filler in the bitumen compound layer (when used) is less than the weight percent of the primary hydrocarbon compound in the bitumen compound layer. The filler can include one or more of calcium carbonate (e.g., oyster shells and other shells of marine organisms, snail shells, coal balls, pearls, eggshells, chalk, limestone, etc.), clay (e.g., recycled tile, recycled clay plates, recycled porcelain, recycled dishes, recycled pots, etc.), dolomite, kaolin (e.g., recycled porcelain, recycled china, feldspar, etc.), silica, talc, etc.; however, other or additional filler can be used. In one non-limiting formulation, the filler (when used) includes calcium carbonate, silica, and/or talc. In another non-limiting formulation, the filler (when used) includes calcium carbonate. In another non-limiting formulation, the filler (when use), includes calcium carbonate, and 5-100% (and all values and ranges therebetween) of the calcium carbonate comes from a recycled and/or non-mined source (e.g., oyster shells and other shells of marine organisms, snail shells, coal balls, pearls, eggshells, etc.). In another non-limiting formulation, the filler (when used) includes calcium carbonate and one or more other filler, and wherein the 5-100% of the calcium carbonate comes from a recycled and/or non-mined source, and wherein 5-100% (and all values and ranges therebetween) of the one or more other fillers comes from a recycled and/or non-mined source.

The polymer modifier, when included in the bitumen compound layer, constitutes about 0.05-45 wt. % (and all values and ranges therebetween) of the bitumen compound layer. In one non-limiting formulation, the polymer modifier (when used) constitutes 0.1-35 wt. % of the bitumen compound layer. In another non-limiting formulation, the polymer modifier (when used) constitutes 5-30 wt. % of the bitumen compound layer. In another non-limiting formulation, the weight percent of polymer modifier in the bitumen compound layer (when used) is less than the weight percent of the primary hydrocarbon compound in the bitumen compound layer. The polymer modifier can include one or more of) polymer modifier (e.g., APAO [amorphous polyolefin], APP [atactic polypropylene], EVA [ethylene vinyl acetate], EBA [ethylene butyl acrylate], PPA [polyphthalamide], PPI [polymeric polyisocyanate], PE [polyethylene], PA [polyamide], PP [polypropylene] SEBS [styrene ethylene butadiene styrene], SBS [styrene butadiene styrene], SIS [styrene-isoprene-styrene], thermoplastic urethane [TPU], reactive elastomeric terpolymers [RET], etc.); however, other or additional polymer modifier can be used. In one non-limiting formulation, the polymer modifier includes one or more of SBS, polyurethane, polyamide, polyether, and/or reactive elastomeric terpolymers [RET]. In another non-limiting formulation, the polymer modifier includes SBS, block copolymers made up of rigid polyamide blocks and soft polyether blocks (e.g., Pebax® Elastomers, etc.) and reactive elastomeric terpolymers [RET]. In another non-limiting embodiment, the polymer modifier includes two or more different polymer modifiers. In another non-limiting embodiment, the polymer modifier includes three or more different polymer modifiers. In another non-limiting embodiment, the polymer modifier includes four or more different polymer modifiers. In another non-limiting embodiment, the polymer modifier includes 0-20 wt. % SBS (and all values and ranges therebetween), 0-20 wt. % block copolymers made up of rigid polyamide blocks and soft polyether blocks (and all values and ranges therebetween), and 0-20 wt. % reactive elastomeric terpolymers [RET] (and all values and ranges therebetween). In another non-limiting formulation, the polymer modifier includes 0.5-100% (and all values and ranges therebetween) recycled polymer material. In another non-limiting formulation, the polymer modifier includes 60-100% recycled polymer material. Non-limiting recycled plastics and/or polymer include recycled plastic bottles (e.g., recycled polyethylene bottles and/or containers, recycled polypropylene bottles and/or containers, etc.), recycled plastic or polymer components from vehicles (e.g., plastic window and windshield trim, etc.), recycled plastic or polymers from other sources (e.g., plastic agricultural products, consumer bags, plastic from recycled consumer products and appliances, recycles vinyl siding, recycles plastic panels, recycled industrial equipment, etc.), recycled polyolefin plastics, recycled synthesized plastics, etc.

The process oil or hydrocarbon resin, when included in the bitumen compound layer, is about 0.05-30 wt. % (and all values and ranges therebetween) of the bitumen compound layer. In one non-limiting formulation, the process oil or hydrocarbon resin (when used) constitutes 0.05-20 wt. % of the bitumen compound layer. In another non-limiting formulation, the process oil or hydrocarbon resin (when used) constitutes 0.1-10 wt. % of the bitumen compound layer. In another non-limiting formulation, the process oil or hydrocarbon resin (when used) constitutes 0.1-3 wt. % of the bitumen compound layer. In another non-limiting formulation, the weight percent of process oil or hydrocarbon resin in the bitumen compound layer (when used) is less than the weight percent of the primary hydrocarbon compound in the bitumen compound layer. The hydrocarbon resin or process oil can include one or more of naphthenic oil, paraffinic oil, C5-C9 aromatic hydrocarbon, etc. In one non-limiting formulation, the hydrocarbon resin or process oil includes naphthenic oil and/or paraffinic oil; however, other or additional hydrocarbon resin or process oil can be used.

The ground tire rubber, when included in the bitumen compound layer, is about 0.5-25 wt. % (and all values and ranges therebetween) of the bitumen compound layer. In one non-limiting formulation, the ground tire rubber (when used) constitutes 0.5-10 wt. % of the bitumen compound layer. In another non-limiting formulation, the ground tire rubber (when used) constitutes 0.8-8 wt. % of the bitumen compound layer. In another non-limiting formulation, the ground tire rubber (when used) constitutes 1-5 wt. % of the bitumen compound layer. In another non-limiting formulation, the weight percent of ground tire rubber in the bitumen compound layer (when used) is less than the weight percent of the primary hydrocarbon compound in the bitumen compound layer. The size of the ground tire rubber has been found to be important. Particles of ground tire rubber that are too large can adversely affect flexibility and other properties of the bitumen compound layer. It has been found that the average particle size of the ground tire rubber that no greater than 100 mesh (149 microns) imparts the desired properties to the bitumen compound layer. In one non-limiting embodiment, the average particle size of the ground tire rubber is 100 mesh (149 microns) to 400 mesh (37 microns) (and all values and ranges therebetween). In another non-limiting embodiment, the average particle size of the ground tire rubber is 100 mesh (149 microns) to 200 mesh (74 microns). In another non-limiting embodiment, the average particle size of the ground tire rubber is 120 mesh (125 microns) to 170 mesh (88 microns). In another non-limiting embodiment, the tire rubber includes one or more of butadiene rubber and styrene butadiene rubber, and optionally natural rubber.

The antioxidant, when included in the bitumen compound layer, is about 0.01-30 wt. % (and all values and ranges therebetween) of the bitumen compound layer. In one non-limiting formulation, the antioxidant (when used) constitutes 0.02-5 wt. % of the bitumen compound layer. In another non-limiting formulation, the antioxidant (when used) constitutes 0.05-1 wt. % of the bitumen compound layer. In another non-limiting formulation, the weight percent of antioxidant in the bitumen compound layer (when used) is less than the weight percent of the primary hydrocarbon compound in the bitumen compound layer. The antioxidant can include one or more of aromatic amines, hindered phenolics, phosphites, sulfur-containing compounds (e.g., thioethers, thioesters, etc.); however, other or additional antioxidant can be used.

The UV stabilizer, when included in the bitumen compound layer, is about 0.01-30 wt. % (and all values and ranges therebetween) of the bitumen compound layer, and typically constitutes 0.02-5 wt. % of the bitumen compound layer. In another non-limiting formulation, the UV stabilizer (when used) constitutes 0.05-1 wt. % of the bitumen compound layer. In another non-limiting formulation, the weight percent of UV stabilizer in the bitumen compound layer (when used) is less than the weight percent of the primary hydrocarbon compound in the bitumen compound layer. The UV stabilizer can include one or more of benzotriazole UV absorber, hindered amine radical scavenger (e.g., Light Stabilizer 770 [Bis(2,2,6,6-tetramethyl-4-piperidine) sebacate], etc.), hindered amine light stabilizer (HALS) (e.g., derivatives of tetramethylpiperidine, etc.), layered double hydroxide (LDH), carbon black, etc.; however, other or additional UV stabilizer can be used.

The fire retardant, when included in the bitumen compound layer, is about 0.05-30 wt. % (and all values and ranges therebetween) of the bitumen compound layer. In one non-limiting formulation, the fire retardant (when used) constitutes 0.05-25 wt. % of the bitumen compound layer. In another non-limiting formulation, the fire retardant (when used) constitutes 0.05-20 wt. % of the bitumen compound layer. In another non-limiting formulation, the fire retardant (when used) constitutes 0.05-15 wt. % of the bitumen compound layer. In another non-limiting formulation, the weight percent of fire retardant in the bitumen compound layer (when used) is less than the weight percent of the primary hydrocarbon compound in the bitumen compound layer. The fire retardant can include one or more of alumina trihydrate (ATH), ammonium polyphosphate (APP), melamine poly(zinc phosphate) (MPZP), MPP melamine polyphosphate, magnesium hydroxide (MgOH), antimony trioxide (ATO), melamine, etc.; however, other or additional fire retardant can be used. In another non-limiting embodiment, the fire retardant can include a blend of ATH and MPZP. In another non-limiting embodiment, the fire retardant can include ATH, APP, and MPZP, and the weight ratio of ATH to APP is 1.1:1 to 45:1 (and all values and ranges therebetween), and the weight ratio of the ATH to MPZP is 1.1:1 to 45:1 (and all values and ranges therebetween).

The wax, when included in the bitumen compound layer, is about 0.05-15 wt. % (and all values and ranges therebetween) of the bitumen compound layer. In one non-limiting formulation, the wax (when used) constitutes 0.05-5 wt. % of the bitumen compound layer. In another non-limiting formulation, the wax (when used) constitutes 0.1-3 wt. % of the bitumen compound layer. In another non-limiting formulation, the weight percent of wax (when used) in the bitumen compound layer is less than the weight percent of the primary hydrocarbon compound in the bitumen compound layer. The wax can include paraffin wax, polypropylene wax, Fischer-Tropsch wax, ester wax, amide wax, THP wax, microcrystalline wax, etc.; however, other or additional waxes can be used.

The reinforcement fibers, when included in the bitumen compound layer, are about 0.05-40 wt. % (and all values and ranges therebetween) of the bitumen compound layer. In one non-limiting formulation, the reinforcement fibers (when used) constitute 0.05-30 wt. % of the bitumen compound layer. In another non-limiting formulation, the reinforcement fibers (when used) constitute 0.05-25 wt. % of the bitumen compound layer. In another non-limiting formulation, the weight percent of reinforcement fibers (when used) in the bitumen compound layer is less than the weight percent of the primary hydrocarbon compound in the bitumen compound layer. Generally, the reinforcement fibers are dispersed in the bitumen compound layer and do not form a layer in the bitumen compound layer or the bitumen roofing membrane. In one non-limiting arrangement, the reinforcement fibers are uniformly dispersed in the bitumen compound layer and do not form a layer in the bitumen compound layer; however, this is not required.

The reinforcement fibers can include one or more of aramid fibers (e.g., poly-para-phenylene terephthalamide [Kevlar®]), carbon fibers, fiberglass, boron fibers, polyethylene fibers, polypropylene fibers, recycled polymer, and/or plastic fibers. In another non-limiting formulation, the reinforcement fibers are formed of 0.5-100% (and all values and ranges therebetween) recycled polymer material. In another non-limiting formulation, the reinforcement fibers are formed of 60-100% recycled polymer material. Non-limiting recycled plastics and/or polymers include recycled plastic bottles (e.g., recycled polyethylene bottles and/or containers, recycled polypropylene bottles and/or containers, etc.), recycled plastic or polymer components from vehicles (e.g., plastic window and windshield trim, etc.), recycled plastic or polymers from other sources (e.g., plastic agricultural products, consumer bags, plastic from recycled consumer products and appliances, recycles vinyl siding, recycles plastic panels, recycled industrial equipment, etc.), recycled polyolefin plastics, recycled synthesized plastics, etc. In one non-limiting embodiment, the length of the reinforcement fibers (when used) have an average length of 1 micron to 30 mm (and all values and ranges therebetween).

The tackifying agent, when included in the bitumen compound layer, is about 0.05-30 wt. % (and all values and ranges therebetween) of the bitumen compound layer. In one non-limiting formulation, the tackifying agent (when used) constitutes 0.05-5 wt. % of the bitumen compound layer. In another non-limiting formulation, the tackifying agent (when used) constitutes 0.05-2 wt. % of the bitumen compound layer. In another non-limiting formulation, the weight percent of tackifying agent (when used) in the bitumen compound layer is less than the weight percent of the primary hydrocarbon compound in the bitumen compound layer. The tackifying agent can include one or more of inorganic salt electrolytes and organic tackifiers, etc.; however, other or additional tackifying agent can be used.

The softening agent, when included in the bitumen compound layer, is about 0.05-30 wt. % (and all values and ranges therebetween) of the bitumen compound layer. In one non-limiting formulation, the softening agent (when used) constitutes 0.05-5 wt. % of the bitumen compound layer. In another non-limiting formulation, the softening agent (when used) constitutes 0.05-2 wt. % of the bitumen compound layer. In another non-limiting formulation, the weight percent of softening agent (when used) in the bitumen compound layer is less than the weight percent of the primary hydrocarbon compound in the bitumen compound layer.

In one non-limiting embodiment, the weight percent of the primary hydrocarbon compound in the bitumen compound layer is greater than the combined weight percent of filler, polymer modifier, hydrocarbon resin or process oil, tackifying agent, antioxidant, UV stabilizer, fire retardant, wax, ground tire rubber, and reinforcement fibers in the bitumen compound layer.

In another non-limiting embodiment, the weight percent of the primary hydrocarbon compound in the bitumen compound layer is greater than the combined weight percent of polymer modifier, hydrocarbon resin or process oil, tackifying agent, antioxidant, UV stabilizer, fire retardant, wax, ground tire rubber, and reinforcement fibers in the bitumen compound layer.

In another non-limiting embodiment, the weight percent of the primary hydrocarbon compound in the bitumen compound layer is greater than the combined weight percent of filler, polymer modifier, hydrocarbon resin or process oil, antioxidant, UV stabilizer, fire retardant, wax, ground tire rubber, and reinforcement fibers in the bitumen compound layer.

In another non-limiting embodiment, the weight percent of the primary hydrocarbon compound in the bitumen compound layer is greater than the combined weight percent of polymer modifier, hydrocarbon resin or process oil, antioxidant, UV stabilizer, fire retardant, wax, ground tire rubber, and reinforcement fibers in the bitumen compound layer.

In another non-limiting embodiment, the weight percent of the primary hydrocarbon compound in the bitumen compound layer is greater than the combined weight percent of polymer modifier, hydrocarbon resin or process oil, antioxidant, UV stabilizer, fire retardant, wax, and ground tire rubber in the bitumen compound layer.

In another non-limiting embodiment, the bitumen compound layer is partially or fully formed of a rubber-bitumen-containing ground tire rubber and one or more of SBS, SEBS, SIS, or other rubber polymers known in the art. The bitumen compound layer can optionally contain fire retardants. The bitumen compound layer can optionally be reinforced to add internal strength to the bitumen compound layer.

In another non-limiting embodiment, the thickness of the entire bitumen compound layer is generally 10-250 mil (0.01-0.25 in.) (and all values and ranges therebetween). In one non-limiting arrangement, the thickness of the entire bitumen compound layer is generally 20-150 mil. In another non-limiting arrangement, the thickness of the entire bitumen compound layer is generally 40-130 mil. In another non-limiting arrangement, the thickness of the entire bitumen compound layer is generally 80-100 mil.

In another non-limiting embodiment, the bitumen compound layer forms a waterproofing layer on the bitumen roofing membrane.

Non-limiting examples of the composition of the bitumen compound layer (absent any optional fiber reinforcement layer) are as follows:

### EXAMPLE 1

| | |
|---|---|
| Primary hydrocarbon compound | 25-90 wt. % |
| Filler | 0-66 wt. % |
| Polymer Modifier | 0-40 wt. % |
| Hydrocarbon Resin Process Oil | 0-30 wt. % |
| Ground Tire Rubber (no greater than | 0-25 wt. % |
| 100 mesh average size) | |
| Antioxidant | 0-30 wt. % |
| UV Stabilizer | 0-30 wt. % |
| Fire Retardant | 0-35 wt. % |
| Wax | 0-15 wt. % |
| Fiber reinforcement | 0-50 wt. %. |

### EXAMPLE 2

| | | |
|---|---|---|
| Primary hydrocarbon compound | 25-80 | wt. % |
| Filler (e.g., calcium carbonate, | 0.5-60 | wt. % |
| silica, talc, etc.) | | |
| Polymer Modifiers (e.g., SBS, | 0.05-35 | wt. % |
| block copolymers made up of | | |
| rigid polyamide blocks and | | |
| soft polyether blocks, reactive | | |
| elastomeric terpolymers [RET]) | | |
| Ground Tire Rubber (no | 0-20 | wt. % |
| greater than 100 mesh average | | |
| size) | | |
| Hydrocarbon Resin Process Oil | 0-20 | wt. % |
| (e.g., naphthenic oil, paraffinic | | |
| oil, etc.) | | |
| Antioxidant | 0-5 | wt. % |
| UV Stabilizer | 0-5 | wt. % |
| Fire Retardant | 0-35 | wt. % |
| Wax | 0-5 | wt. % |
| Fiber reinforcement | 0-40 | wt. % |

(e.g., fiber, etc.)

### EXAMPLE 3

| | | |
|---|---|---|
| Primary hydrocarbon compound | 25-60 | wt. % |
| Filler (e.g., calcium carbonate, | 0.5-60 | wt. % |
| silica, talc, etc.) | | |
| Polymer Modifier | 0.05-35 | wt. % |
| (e.g., SBS, block copolymers | | |
| made up of rigid polyamide | | |
| blocks and soft polyether blocks, | | |
| reactive elastomeric | | |
| terpolymers [RET]) | | |
| Ground Tire Rubber | 0-15 | wt. % |
| 100-200 mesh average size) | | |
| Hydrocarbon Resin Process Oil | 0-15 | wt. % |
| (e.g., naphthenic | | |
| oil, paraffinic oil, etc.) | | |
| Antioxidant | 0-2 | wt. % |
| UV Stabilizer | 0-2 | wt. % |
| Fire Retardant | 0-30 | wt. % |
| Wax | 0-2 | wt. % |
| Fiber reinforcement | 0-40 | wt. %. |
| (e.g., fiber, etc.) | | |

### EXAMPLE 4

| | | |
|---|---|---|
| Primary hydrocarbon compound | 25-55 | wt. % |
| Filler (e.g., calcium carbonate, | 0.05-60 | wt. % |
| silica, talc, etc.) | | |
| Polymer Modifier | 0.05-35 | wt. % |
| (e.g., SBS, block copolymers | | |
| made up of rigid polyamide | | |
| blocks and soft polyether blocks, | | |
| reactive elastomeric | | |
| terpolymers [RET]) | | |
| Ground Tire Rubber | 0-12 | wt. % |
| 100-200 mesh average size) | | |
| Hydrocarbon Resin Process Oil | 0-5 | wt. % |
| (e.g., naphthenic | | |
| oil, paraffinic oil, etc.) | | |
| Antioxidant | 0-2 | wt. % |
| UV Stabilizer | 0-2 | wt. % |
| Fire Retardant | 0-30 | wt. % |
| Wax | 0-4 | wt. % |
| Fiber reinforcement | 0-40 | wt. % |
| (e.g., fiber, etc.) | | |

### EXAMPLE 5

| | | |
|---|---|---|
| Primary hydrocarbon compound | 40-80 | wt. % |
| (e.g., 80-100 wt. % bitumen) | | |
| Filler (e.g., calcium carbonate, | 0-60 | wt. % |
| silica, talc, etc.) | | |
| Polymer Modifier | 0.05-35 | wt. % |
| (e.g., SBS, block copolymers | | |
| made up of rigid polyamide blocks and | | |
| soft polyether blocks, reactive | | |
| elastomeric terpolymers [RET]) | | |
| Ground Tire Rubber | 0-15 | wt. % |
| 100-200 mesh average size) | | |
| Hydrocarbon Resin or Process Oil | 0-15 | wt. % |
| (e.g., naphthenic oil, paraffinic oil, etc.) | | |
| Antioxidant | 0-1 | wt. % |
| UV Stabilizer | 0-1 | wt. % |
| Wax | 0-4 | wt. % |
| Fire Retardant | 0-28 | wt. % |
| Fiber reinforcement (e.g., fiber, etc. | 0-40 | wt. %. |
| Fiber reinforcement can be formed of | | |
| Non-Recycled And/or Recycled material) | | |

### EXAMPLE 6

| | | |
|---|---|---|
| Primary hydrocarbon compound | 25-65 | wt. % |
| (e.g., 80-100 wt. % bitumen) | | |
| Filler (e.g., calcium carbonate, silica, talc, etc.; | 5-40 | wt. % |
| Filler can be formed of Non-Recycled | | |
| And/or Recycled material) | | |
| Polymer Modifier (e.g., SBS, block copolymers | 0.05-35 | wt. % |
| made up of rigid polyamide blocks and | | |
| soft polyether blocks, reactive elastomeric | | |
| terpolymers [RET]) | | |
| Ground Tire Rubber | 0-12 | wt. % |
| 100-200 mesh average size) | | |
| Hydrocarbon Resin or Process Oil | 0-15 | wt. % |
| (e.g., naphthenic oil, paraffinic oil, etc.) | | |
| Antioxidant | 0-1 | wt. % |
| UV Stabilizer | 0-1 | wt. % |
| Wax | 0-3 | wt. % |
| Fire Retardant | 0-25 | wt. % |
| (e.g., alumina trihydrate, | | |
| ammonium polyphosphate, | | |
| melamine poly(zinc phosphate), etc.) | | |
| Fiber reinforcement (e.g., fiber, etc. | 0-40 | wt. %. |

Fiber reinforcement can be formed of
Non-Recycled And/or Recycled material)

### EXAMPLE 7

| | | |
|---|---|---|
| Primary hydrocarbon compound | 40-60 | wt. % |
| (e.g., 80-100 wt. % bitumen) | | |
| Filler (e.g., calcium carbonate, silica, talc, | 5-35 | wt. % |
| etc.; Filler can be formed of Non-Recycled | | |
| And/or Recycled material) | | |
| Polymer Modifier | 0.05-35 | wt. % |
| (e.g., SBS, block copolymers | | |
| made up of rigid polyamide blocks and | | |
| soft polyether blocks, reactive elastomeric | | |
| terpolymers [RET]) | | |
| Ground Tire Rubber | 0-10 | wt. % |
| 100-200 mesh average size) | | |
| Hydrocarbon Resin or Process Oil | 0-10 | wt. % |
| (e.g., naphthenic oil, paraffinic oil, etc.) | | |
| Antioxidant | 0-1 | wt. % |
| UV Stabilizer | 0-1 | wt. % |
| Wax | 0-3 | wt. % |
| Fire Retardant | 1-25 | wt. % |
| (e.g., alumina trihydrate, | | |
| ammonium polyphosphate, | | |
| melamine poly(zinc phosphate), etc.) | | |
| Fiber reinforcement (e.g., fiber, etc.; | 0-40 | wt. %. |

Fiber reinforcement can be formed of
Non-Recycled And/or Recycled material)

### EXAMPLE 8

| | | |
|---|---|---|
| Primary hydrocarbon compound | 45-60 | wt. % |
| (e.g., 80-100 wt. % bitumen; | | |
| 80-100 asphalt) | | |
| Filler (e.g., calcium carbonate, silica, talc, etc.; | 7-35 | wt. % |
| Filler can be formed of Non-Recycled | | |
| And/or Recycled material) | | |
| Polymer Modifier (e.g., SBS, block copolymers | 0.05-35 | wt. % |
| made up of rigid polyamide blocks and | | |
| soft polyether blocks, reactive elastomeric | | |
| terpolymers [RET]; etc .; Polymer Modifier | | |
| can be formed of Non-Recycled And/or | | |
| Recycled material) | | |
| Ground Tire Rubber | 0-8 | wt. % |
| 100-200 mesh average size) | | |
| Hydrocarbon Resin or Process Oil | 0.1-6 | wt. % |
| (e.g., naphthenic oil, paraffinic oil, etc.) | | |
| Antioxidant | 0.1-1 | wt. % |
| UV Stabilizer | 0.1-1 | wt. % |
| Wax | 0-3 | wt. % |
| Fire Retardant | 2-22 | wt. % |
| (e.g., alumina trihydrate, | | |
| ammonium polyphosphate, | | |
| melamine poly(zinc phosphate), etc.) | | |
| Fiber reinforcement (e.g., fiber, etc.) | 0-40 | wt. %. |

### EXAMPLE 9

| | | |
|---|---|---|
| Primary hydrocarbon compound | 50-60 | wt. % |
| (e.g., 80-100 wt. % bitumen; | | |
| 80-100 asphalt) | | |
| Filler | 20-30 | wt. % |
| (e.g., calcium carbonate, silica, talc, etc.; | | |
| Filler can be formed of Non-Recycled | | |
| And/or Recycled material) | | |
| Polymer Modifier | 10-30 | wt. % |
| (e.g., SBS, block copolymers | | |
| made up of rigid polyamide blocks and | | |
| soft polyether blocks, reactive elastomeric | | |
| terpolymers [RET]; etc .; Polymer Modifier | | |
| can be formed of Non-Recycled And/or | | |
| Recycled material) | | |
| Ground Tire Rubber | 0-8 | wt. % |
| 100-200 mesh average size) | | |
| Hydrocarbon Resin or Process Oil | 0.1-6 | wt. % |
| (e.g., naphthenic oil, paraffinic oil, etc.) | | |
| Antioxidant | 0.1-1 | wt. % |
| UV Stabilizer | 0.1-1 | wt. % |
| Wax | 0-3 | wt. % |
| Fire Retardant | 2-22 | wt. % |
| (e.g., alumina trihydrate, | | |
| ammonium polyphosphate, | | |
| melamine poly(zinc phosphate), etc.) | | |
| Fiber reinforcement (e.g., fiber, etc.) | 0-40 | wt. %. |

In Examples 1-9, it will be appreciated that all of the above ranges include any value between the range and any other range that is between the ranges set forth above.

### The Fiber Reinforcement Layer

One or more fiber reinforcement layers can optionally be used as a reinforcement for the modified bitumen sheet/membrane. The one or more fiber reinforcement layers (when used) can be a) applied on or above the top surface of the modified bitumen sheet/membrane, b) applied on or below the bottom surface of the modified bitumen sheet/membrane, or c) be impregnated or otherwise positioned within the modified bitumen sheet/membrane. As can be appreciated, multiple fiber reinforcement layers can be used. The one or more fiber reinforcement layers (when used) are different from the fiber reinforcement (when used) in the bitumen compound layer in that the one or more fiber reinforcement layers form a layer of material in the bitumen compound layer and/or the bitumen roofing membrane, whereas the fiber reinforcement (when used) in the bitumen compound layer are dispersed in the bitumen compound layer and do not form a layer in the bitumen compound layer. As can be appreciated, the materials used to form the fiber reinforcement (when used), in the bitumen compound layer and the materials used to form the one or more fiber reinforcement layers can be the same or different.

In one non-limiting embodiment, the fiber reinforcement layer can be in the form of woven mat, non-woven mat, woven and nonwoven mat, sheet, one or more rovings, one or more rows of rovings, etc.

In another non-limiting embodiment, the fiber reinforcement layer can be formed of one or more of fiberglass, nylon, polyester, polycrystalline fibers, cotton, cellulose, silk, wool, hemp, straw, bamboo, flax, ramie, hemp, sisal, wool, linen (flax), jute, modal, asbestos fibers, basalt fibers, aramid fiber, acrylic fiber, polyurethane fiber, olefin fiber, rayon fiber, polylactide fiber, lurex fiber, carbon fibers, boron fibers, polyethylene fibers, polyolefin fibers, polyurethane fibers, vinyl polymer fibers, polyamide fibers, aromatic polyamide or aramid fibers (e.g., Kevlar™, Twaron™, etc.), polyethylene fibers, polypropylene fibers, thermoplastic fiber filaments (e.g., polyamide fibers of poly(p-phenylene terephthalate), poly(o-phenylene terephthalamide), ultra-low shrink polyester), recycled polymer fibers, recycled, plastic fibers, and any blend of these materials. The fibers can be continuous filaments, fibers, strands and/or yarn; however, this is not required.

Each of the fiber reinforcement layers have a thickness than is generally thinner than the thickness of the modified bitumen sheet/membrane. Generally, the thickness ratio of the modified bitumen sheet/membrane to each of the fiber reinforcement layers is generally at least about 1.1:1 (e.g., 1.1:1 to 200:1 and all values and ranges therebetween), typically at least about 1.5:1, and more typically about 2:1 to 100:1; however, other thickness ratios can be used. The thickness of each of the fiber reinforcement layer is generally at least about 1 mil (0.001 inch) (e.g., 1-300 mills and all values and ranges therebetween), typically at least about 1.5 mils, and more typically about 2-100 mils; however, other thickness can be used.

In another non-limiting embodiment, the one or more reinforcement layers can be partially or fully saturated/encapsulated with the modified bitumen sheet/membrane; however, this is not required.

In another non-limiting embodiment, the one or more reinforcement layers can be secured to the modified bitumen sheet/membrane by a variety of arrangements (e.g., being partial or fully impregnated in the modified bitumen sheet/membrane, adhesive, melted connection, stitching, staples, rivets, clamp, etc.).

In another non-limiting embodiment, the one or more reinforcement layers are generally flexible to enable the modified bitumen sheet/membrane to be rolled into a roll of modified bitumen sheet/membrane which would otherwise cause damage to the modified bitumen sheet/membrane. In one non-limiting configuration, the fiber reinforcement layer can be rolled into a roll having a diameter of eight in, or less without damaging the fiber reinforcement layer.

In another non-limiting embodiment, when the fiber reinforcement layer is impregnated in the modified bitumen sheet/membrane, the fiber reinforcement layer can optionally be located at or near the mid-thickness of the modified bitumen sheet/membrane; however, this is not required.

In another non-limiting embodiment, the one or more reinforcement layers provide reinforcement and internal strength to the modified bitumen sheet/membrane.

In another non-limiting embodiment, the fiber reinforcement layer generally extends 1-100% (and all values and ranges therebetween) of the width of the modified bitumen sheet/membrane, and 1-100% (and all values and ranges therebetween) of the length of the modified bitumen sheet/membrane. In one non-limiting configuration, the fiber reinforcement layer extends 90-100% of the width of the modified bitumen sheet/membrane, and 90-100% of the length of the modified bitumen sheet/membrane.

In another non-limiting embodiment, when the modified bitumen sheet/membrane includes two or more fiber reinforcement layers, the fiber reinforcement layers are generally spaced from one another; however, this is not required.

In another non-limiting embodiment, when the modified bitumen sheet/membrane includes two or more fiber reinforcement layers, the thickness of each of the fiber reinforcement layers can be the same or different.

In another non-limiting embodiment, one non-limiting purpose of the one or more fiber reinforcement layers is to act as a reinforcement layer for the modified bitumen sheet/membrane. Another non-limiting optional purpose of the one or more fiber reinforcement layers is to strengthen the modified bitumen sheet/membrane.

In another non-limiting embodiment, the fiber reinforcement layer generally covers or spans 50-100% (and all values and ranges therebetween) of the width of the modified bitumen sheet/membrane. When the fiber reinforcement layer covers less than 100% of the width of the modified bitumen sheet/membrane, the fiber reinforcement layer can optionally be used to form a lap line region. The width of the lap line region (when used) is generally 0.5-6 in. (and all values and ranges therebetween), typically the width of the lap line region is 1-5 in., and more typically, the width of the lap line region is 3-4 in.

In another non-limiting embodiment, the fiber reinforcement layer can be made wide enough to optionally overhang one or more edges of the modified bitumen sheet/membrane to form a ready-made lap that ties into the adjacent modified bitumen sheet/membrane. This overhanging edge can have a length or width of 0.5-10 in. (and all values and ranges therebetween).

In another non-limiting embodiment, when the fiber reinforcement layer is used to form a lap line region, the lap line region can optionally include a release material (e.g., polymeric liner, paper liner, etc.). Such release material can be of similar composition and thickness as the optional release liner that can be included in the bottom surface of the modified bitumen sheet/membrane as discussed below, or can be of similar composition and thickness as the optional release film that can be included on the top surface of the fiber reinforcement layer as discussed below.

In another non-limiting embodiment, the fiber reinforcement layer may be a woven mat, a non-woven mat, a mat formed by non-overlapping fibers (e.g., rovings, etc.), or a mat formed by overlapping fibers. In one non-limiting configuration, the fiber reinforcement layer is a woven mat. In another non-limiting configuration, the fiber reinforcement layer can be partially or fully formed of fibers that are 0.2-50 in. in length (and all values and ranges therebetween) and are optionally partially or fully held together by a binder (e.g., polymeric binder, etc.), stitching, and/or weaving; and typically the fiber reinforcement layer is partially or fully formed of fibers that are 0.3-15 in. in length and are partially or fully held together by a binder and/or stitching and/or weaving. In another non-limiting arrangement, the fiber reinforcement layer is formed of a plurality of fibers that are oriented in multiple directions from one another (e.g., multi-directional fiber reinforcement layer) and such fibers are bonded together by a polymeric binder material (e.g., acrylic binder, etc.), stitched together, and/or weaved together and the length of the fibers is 0.1-10 in.

In another non-limiting embodiment, the one or more fiber reinforcement layers can optionally be formed, treated, etc., to be wick resistant to inhibit or prevent moisture from moving through the one or more fiber reinforcement layers. As such, the one or more fiber reinforcement layers can a) be formed of a wick-resistant material; b) the knitting together of the fibers can be tight to inhibit or resist moisture penetration or wicking of moisture through the fiber reinforcement layer; and/or c) the fibers and/or the fiber reinforcement layer itself can be coated with a material that inhibits or resists moisture penetration or wicking of moisture through the one or more fiber reinforcement layers.

In another non-limiting embodiment, the one or more fiber reinforcement layers can optionally have fire-retardant properties. In non-limiting configuration, the fibers and/or the one or more fiber reinforcement layers can optionally be pre-treated and/or post-treated with one or more fire-retardant materials (e.g., halogenated compound-containing coatings, expandable graphite-containing coatings, etc.).

The reinforcement material can be formed of one or more layers of material. The location of the reinforcement material can be a) between the reflective polymer layer material and the modified bitumen sheet/membrane, b) between two layers of the modified bitumen sheet/membrane, c) on a bottom surface of the modified bitumen sheet/membrane, d) between a bottom surface of the modified bitumen sheet/membrane and an optional backing material, c) between a bottom surface of the modified bitumen sheet/membrane and an optional adhesive layer, f) between a top surface of the modified bitumen sheet/membrane and an optional adhesive layer, and/or g) between a top surface of the modified bitumen sheet/membrane and an optional fleece layer.

In another non-limiting embodiment, the one or more fiber reinforcement layers can optionally include a backing material. The backing material (when used) can be pre-coated on the bottom surface of the one or more fiber reinforcement layers. The backing material (when used) can be formed of a material that facilities in the securing of the one or more fiber reinforcement layers to a) the top surface of the modified bitumen sheet/membrane; or b) the bottom surface of the modified bitumen sheet/membrane. In one non-limiting configuration, the backing material is formed of a bitumen- or asphalt-containing material, a polymeric coating layer, or a polymeric sheet layer. In one non-limiting configuration, the composition of the backing material is different from the composition of the bitumen composition in the modified bitumen sheet/membrane. The thickness of the backing material (when used) is generally at least 0.1 mil (0.0001 in.) and generally no more than 40 mils (0.04 in.) and all values and ranges therebetween).

### The Release Liner or Underside Material

A release liner can optionally form the bottom and/or top surface of the roofing and/or siding system. Such release liner can be formed of a paper (e.g., Kraft paper, super calendared Kraft paper, clay-coated Kraft paper, polymer-coated Kraft paper, glazed paper, etc.) or a polymeric film (e.g., PET film, polypropylene film, polyolefins film, polyethylene films, PP films, etc.), or a paper that is coated with a polymeric film. The thickness of the release liner is generally 0.2-50 mil (and all values and ranges therebetween). In one non-limiting configuration, the thickness of the release liner (when used) is 1-10 mil. In one non-limiting embodiment, the release liner is connected to the bottom surface of the modified bitumen sheet/membrane.

In another non-limiting embodiment, the bottom surface of the roofing and/or siding system can include be sand, ground glass, recycled ground glass, porcelain, slag, and other powders typical in the art.

### Method of Manufacturing

The reflective polymer layer material, when a preformed layer, can optionally be secured to the top surface of the modified bitumen sheet/membrane by the use of an adhesive. The adhesive is used to facilitate in securing the reflective polymer layer material to the modified bitumen sheet/membrane. Pressure (e.g., via pressure rollers, etc.) can be used to facilitate in securing one or more of the layers of the roofing and/or siding system together; however, this is not required.

The reflective polymer layer material can optionally be secured to the top surface of the modified bitumen sheet/membrane by a lamination process. When the modified bitumen sheet/membrane is a bitumen membrane, modified bitumen membrane, asphalt membrane, or the like, the modified bitumen sheet/membrane and the reflective polymer layer material can be secured together by a heat process. In this process, the reflective polymer layer material can be laminated to the modified bitumen sheet/membrane by heating the surface of the modified bitumen sheet/membrane above its softening temperature, and then applying the reflective polymer layer material to the softened surface and permitting the softened material to partially saturate or intermingle with the reflective polymer layer material and/or optional fleece material connected to the bottom of the reflective polymer layer material. Pressure (e.g., via pressure rollers, etc.) can be used to facilitate in securing one or more of the layers of the roofing and/or siding system together; however, this is not required.

One non-limiting object of the present disclosure to provide an improved roofing and/or siding system that has a result or effective reflectivity of at least about 50%.

Another and/or non-limiting alternative object of the present disclosure is the provision of a roofing and/or siding system having an exposed surface of reflective polymer layer material.

Another and/or non-limiting alternative object of the present disclosure is the provision of a roofing and/or siding system that includes one or more layers of reflective polymer layer material.

Another and/or non-limiting alternative object of the present disclosure is the provision of a roofing and/or siding system that includes a reflective polymer layer containing one or more layers wherein the reflective polymer layer is the top layer and the layers beneath the reflective polymer layer are composed of the same or different polymers.

Another and/or non-limiting alternative object of the present disclosure is the provision of a roofing and/or siding system having highly reflective properties that can be manufactured off-site and have the desired resulting or effective reflectivity.

Another and/or non-limiting alternative object of the present disclosure is the provision of a roofing and/or siding system which has a desired weatherability, desired strength and color stability as well as a desired heat stability.

Another and/or non-limiting alternative object of the present disclosure is the provision of a roofing and/or siding system that is commercially feasible and economical to manufacture.

Another and/or non-limiting alternative object of the present disclosure is the provision of a roofing and/or siding system that has a reduced surface temperature when exposed to sunlight.

Another and/or non-limiting alternative object of the present disclosure is the provision of a roofing and/or siding system that reduces energy costs associated with the cooling of a structure.

Another and/or non-limiting alternative object of the present disclosure is the provision of a roofing and/or siding system that resists heat degradation.

Other objects, advantages, and novel features of the present disclosure will become apparent from the following detailed description of the disclosure when considered in conjunction with the accompanying drawing.

### BRIEF DESCRIPTION OF THE DRAWING

Non-limiting and non-exhaustive embodiments are described with reference to the following drawing, wherein like labels refer to like parts throughout the various views unless otherwise specified. The sizes and relative positions of elements in the drawing are not necessarily drawn to scale. For example, the shapes of various elements are selected, enlarged, and positioned to improve drawing legibility. The particular shapes of the elements as drawn have been selected for ease of recognition in the drawing. Reference may now be made to the drawing, which illustrates various embodiments that the disclosure may take in physical form and in certain parts and arrangement of parts wherein:

FIG. 1 is a cross-section view of a roofing and/or siding material in accordance with the present disclosure.

### DETAILED DESCRIPTION OF NON-LIMITING EMBODIMENTS

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 10% of the indicated number.

Although the operations of exemplary embodiments of the disclosed method may be described in a particular, sequential order for convenient presentation, it should be understood that disclosed embodiments can encompass an order of operations other than the particular, sequential order disclosed. For example, operations described sequentially may in some cases be rearranged or performed concurrently. Further, descriptions and disclosures provided in association with one particular embodiment are not limited to that embodiment, and may be applied to any embodiment disclosed.

For the sake of simplicity, the attached figures may not show the various ways (readily discernable, based on this disclosure, by one of ordinary skill in the art) in which the disclosed system, method and apparatus can be used in combination with other systems, methods and apparatuses. Additionally, the description sometimes uses terms such as “produce” and “provide” to describe the disclosed method. These terms are abstractions of the actual operations that can be performed. The actual operations that correspond to these terms can vary depending on the particular implementation and are, based on this disclosure, readily discernible by one of ordinary skill in the art.

The present disclosure is directed to an improved a roofing and/or siding material 10 in accordance with the present disclosure.

The roofing and/or siding material 10 includes one or more layers of a modified bitumen sheet/membrane 40; an optional a reinforcement material 50; and a reflective polymer layer material 20. Modified bitumen sheet/membrane 40 is illustrated as being a modified bitumen composite wherein the modifier is selected from atactic polypropylene (APP), styrene-butadiene-styrene (SBS), styrene-ethylene-butadiene-styrene (SEBS) and styrene-butadiene rubber (SBR), block copolymers made up of rigid polyamide blocks and soft polyether blocks, and/or reactive elastomeric terpolymers [RET]; however, it can be appreciated that the modified bitumen sheet/membrane 40 can be formed of other materials. One non-limiting formulation of the modified bitumen sheet/membrane 40 is illustrated in Table A.

TABLE A

| Material | Wt. % Range |
|---|---|
| Asphalt | 53-56% |
| Processing Oils | 0-5% |
| RET | 0-10% |
| PA/PE Block Copolymer | 0-10% |
| SBS | 0-10% |
| CaCO₃ | 20-30% |
| ATH | 8-11% |
| MPZP | 1-5% |

As illustrated in Table A, the modified bitumen modified bitumen sheet membrane 40 can be formed of a blend of block copolymers (e.g., polyacrylate and polyethylene block copolymer, etc.), which blend of block copolymers can optionally be made up of rigid polyamide blocks and soft polyether blocks (sold under the Pebax® brand from Arkema), reactive ethylene terpolymers (sold under the Elvaloy® brand by Dow), and rubber modifiers such as, but not limited to, atactic polypropylene (APP), styrene-butadiene-styrene (SBS), styrene-ethylene-butadiene-styrene (SEBS), and styrene-butadiene rubber (SBR) or blends of rubber modifiers; however, it can be appreciated that the modified bitumen sheet/membrane 40 can be formed of other modifiers. The modified bitumen modified bitumen sheet membrane 40 can also include processing oils such as heavy paraffinic distillates to aid in improving flexibility such as Hydrolene SP125 by HollyFrontier, fillers such as CaCO₃, and fire retardants such as aluminum trihydroxide (ATH), melamine poly(zinc phosphate). Additionally, additives such as antioxidants and/or UV stabilizers can be optionally added to the modified bitumen modified bitumen sheet membrane 40. It is appreciated that all of the above ranges in Table include any value between the range and any other range that is between the ranges set forth above.

The thickness of each of the layers of the modified bitumen sheet/membrane 40 that is form of modified bitumen composite is about 10-200 mils (and all values and ranges therebetween). The modified bitumen sheet/membrane 40 that is form of modified bitumen composite can optionally include a scrim material, not shown, of polyethylene, polyester of the like having a thickness of about 0.02-1 mm (and all values and ranges therebetween). A non-limiting manufacturing process for forming modified bitumen composite is described in United States Patent Publication No. 2004/0071938 published on Apr. 15, 2004, which is incorporated herein by reference, thus will not be described further.

The bottom surface of the modified bitumen sheet/membrane 40 includes a removable release liner 60. The release liner is generally formed of a polymer material; however, release liner 60 can be formed of other material (e.g., paper, etc.). The release liner is designed to preform one or more functions, namely, 1) reduce the incidence of adhesion of the bottom of the modified bitumen sheet/membrane 40 to a top surface of the reflective polymer layer material 20 when the roofing and/or siding material 10 is rolled into a roll for shipping and/or storage, 2) reduce the incidence of damage to the bottom of the modified bitumen sheet/membrane 40 and/or to the top surface of the reflective polymer layer material 20 when the roofing and/or siding material 10 is rolled into a roll for shipping and/or storage, 3) prevent or reduce the incidence of discoloration of the top surface of the reflective polymer layer material 20 by the bottom of the modified bitumen sheet/membrane 40 when the roofing and/or siding material 10 is rolled into a roll for shipping and/or storage, and/or 4) improve the case of unrolling roofing and/or siding material 10. The removable release liner 60 and/or bottom of the modified bitumen sheet/membrane 40 can include an adhesive to maintain the removable release liner 60 on the bottom of the modified bitumen sheet/membrane 40 and to also enable the removable release liner 60 to be easily removed from the bottom of the modified bitumen sheet/membrane 40; however, it will be appreciated that the use of an adhesive is not required. The thickness of the removable release liner 60 is generally about 0.2-2 mils (and all values and ranges therebetween); however, other thicknesses can be used. The color of the removable release liner 60 is generally white; however, other colors can be used.

The optional fiber reinforcement layer 50 is generally formed of a polyethylene, polyester and/or fiberglass material; however, other or additional materials can be used. The fiber reinforcement layer 50 is generally a woven material; however, the fiber reinforcement layer 50 can be a non-woven material or a combination of a woven or non-woven material. The thickness of the fiber reinforcement layer 50 is generally about 5-40 mils (and all values and ranges therebetween); however, other thicknesses can be used. The fiber reinforcement layer 50 is illustrates as being positioned between two layers of modified bitumen sheet/membrane 40; however, it will be appreciated that the fiber reinforcement layer 50 can be positioned on the top and/or bottom surface of a single layer of modified bitumen sheet/membrane 40 and/or be at least partially embedded in the top or bottom surface of one or more layers of the modified bitumen sheet/membrane 40.

Reflective polymer layer material 20 is designed and/or formulated to create a resulting reflectivity of at least about 50% on the roofing and/or siding system. Typically, the reflective polymer layer material 20 is designed and/or formulated to create a resulting reflectivity of at least about 70% on the roofing and/or siding system, more typically a resulting reflectivity of about 72-95% on the roofing and/or siding system, and even more typically a resulting reflectivity of about 75-90% on the roofing and/or siding system.

The reflective polymer layer material 20 is formed of one or more layers of polyvinyl fluoride (PVF). The thickness of the reflective polymer layer material 20 is generally about 2-5 mils (and all values and ranges therebetween). The color of the reflective polymer layer material 20 is generally white.

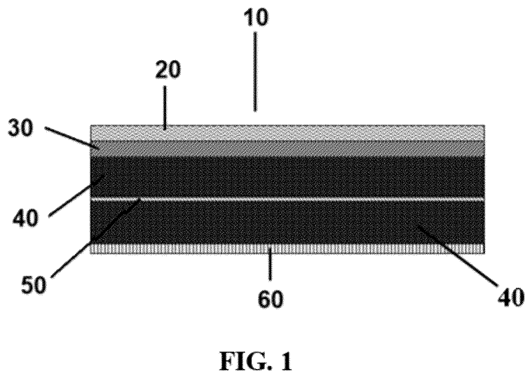

As illustrated in FIG. 1, the reflective polymer layer material 20 is secured to the top surface of modified bitumen sheet/membrane 40 by use of an adhesive layer 30 (e.g., thermoplastic acrylic adhesive, etc.).

The reflective polymer layer material 20 has a thickness that is generally thinner than the thickness of the modified bitumen sheet/membrane. The reflective polymer layer material 20 can have a smooth top surface texture; however, it can be appreciated that the top surface of the reflective polymer layer material 20 can be rough in texture. In one non-limiting embodiment, the top surface of the reflective polymer layer material 20 can optionally be embossed with any pattern, design, shape, and prior to application in the manufacturing process or in a post manufacturing process. In another non-limiting embodiment, the top surface of the reflective polymer layer material 20 can optionally include printed words, numbers, shapes, logos, designs, textures, etc.

Although the operations of exemplary embodiments of the disclosed method may be described in a particular, sequential order for convenient presentation, it should be understood that disclosed embodiments can encompass an order of operations other than the particular, sequential order disclosed. For example, operations described sequentially may in some cases be rearranged or performed concurrently. Further, descriptions and disclosures provided in association with one particular embodiment are not limited to that embodiment, and may be applied to any embodiment disclosed.

The description sometimes uses terms such as “produce” and “provide” to describe the disclosed method. These terms are abstractions of the actual operations that can be performed. The actual operations that correspond to these terms can vary depending on the particular implementation and are, modified bitumen on this disclosure, readily discernible by one of ordinary skill in the art.

It will thus be seen that the objects set forth above, among those made apparent from the preceding description, are efficiently attained, and since certain changes may be made in the constructions set forth without departing from the spirit and scope of the disclosure, it is intended that all matter contained in the above description and shown in the accompanying drawings shall be interpreted as illustrative and not in a limiting sense. The disclosure has been described with reference to preferred and alternate embodiments. Modifications and alterations will become apparent to those skilled in the art upon reading and understanding the detailed discussion of the disclosure provided herein. This disclosure is intended to include all such modifications and alterations insofar as they come within the scope of the present disclosure. It is also to be understood that the following claims are intended to cover all of the generic and specific features of the disclosure herein described and all statements of the scope of the disclosure, which, as a matter of language, might be said to fall therebetween.

To aid the Patent Office and any readers of this application and any resulting patent in interpreting the claims appended hereto, applicants do not intend any of the appended claims or claim elements to invoke 35 U.S.C. 112 (f) unless the words “means for” or “step for” are explicitly used in the particular claim.

What is claimed:

1. A roofing and/or siding material having a resulting reflectivity of at least about 50%, said roofing and/or siding material comprising a modified bitumen sheet/membrane and a reflective polymer layer material; said reflective polymer layer material includes polyvinyl fluoride; said reflective polymer layer material forming at least a portion of a top surface of said roofing and/or siding material.

2. The roofing and/or siding material as defined in claim 1, wherein said reflective polymer layer material is at least partially secured to said modified bitumen sheet/membrane by an adhesive.

3. The roofing and/or siding material as defined in claim 1, wherein said reflective polymer layer material has a thickness of 0.5-100 mils.

4. The roofing and/or siding material as defined in claim 1, wherein said reflective polymer layer material is composed of one or more layers of polyvinyl fluoride.

5. The roofing and/or siding material as defined in claim 1, wherein said modified bitumen sheet/membrane is a bitumen membrane; said bitumen membrane includes a primary hydrocarbon compound and a primary hydrocarbon compound and one or more of a) filler; b) polymer modifier; c) hydrocarbon resin or process oil; d) ground tire rubber; e) antioxidant; f) UV stabilizer; g) fire retardant; h) wax; i) reinforcement fibers; and j) tackifying agent.

6. The roofing and/or siding material as defined in claim 1, wherein said modified bitumen sheet/membrane includes a fiber reinforcement layer.

7. The roofing and/or siding material as defined in claim 6, wherein said fiber reinforcement layer is at least partially embedded in said modified bitumen sheet/membrane.

8. The roofing and/or siding material as defined in claim 6, wherein said fiber reinforcement layer is fully partially embedded in said modified bitumen sheet/membrane.

9. The roofing and/or siding material as defined in claim 6, wherein said fiber reinforcement layer includes polyester, polyethylene and/or fiberglass.

10. The roofing and/or siding material as defined in claim 1, wherein a bottom surface of said modified bitumen sheet/membrane includes a removable release liner; said release liner forms a bottom and/or top surface of said bitumen roofing membrane; said release liner is formed of one or more of paper, a polymeric film, or paper that is coated with polymeric film.

11. The roofing and/or siding material as defined in claim 1, further including a fiber material layer positioned between said top surface of said modified bitumen sheet/membrane and a bottom surface of said reflective polymer layer material; said fiber material layer at least partially impregnated with said adhesive; said fiber material layer having a thickness that is less than a thickness of said modified bitumen sheet/membrane; said fiber material layer is configured to facilitate in securing said reflective polymer layer material to said modified bitumen sheet/membrane; said fiber material layer is formed of a woven or non-woven material.

12. A roofing and/or siding material having a resulting reflectivity of at least about 75%, said roofing and/or siding material comprising a modified bitumen sheet/membrane, a fiber reinforcement layer and a reflective polymer layer material; said reflective polymer layer material includes polyvinyl fluoride; said reflective polymer layer material forming a top surface of said roofing and/or siding material; said reflective polymer layer material is directly secured to a top surface of said modified bitumen sheet/membrane by an adhesive and/or fiber scrim; said reflective polymer layer material has a thickness of 0.5-100 mils; a thickness of said reflective polymer layer material is less than a thickness of said modified bitumen sheet/membrane and/or said fiber reinforcement layer; said reflective polymer layer material consists of one or more layers of polyvinyl fluoride; said modified bitumen sheet/membrane is a bitumen membrane; said bitumen membrane includes a primary hydrocarbon compound and a primary hydrocarbon compound and one or more of a) filler; b) polymer modifier; c) hydrocarbon resin or process oil; d) ground tire rubber; e) antioxidant; f) UV stabilizer; g) fire retardant; h) wax; i) reinforcement fibers; and j) tackifying agent.

13. The roofing and/or siding material as defined in claim 12, wherein said fiber reinforcement layer is partially embedded or fully embedded in said modified bitumen sheet/membrane.

14. The roofing and/or siding material as defined in claim 13, wherein said fiber reinforcement layer includes polyester, polyethylene and/or fiberglass.

15. The roofing and/or siding material as defined in claim 12, wherein a bottom surface of said modified bitumen sheet/membrane includes a removable release liner; said release liner forms a bottom and/or top surface of said bitumen roofing membrane; said release liner is formed of one or more of paper, a polymeric film, or paper that is coated with polymeric film.

16. The roofing and/or siding material as defined in claim 12, wherein said modified bitumen sheet/membrane comprises:

| | | |
|---|---|---|
| Primary hydrocarbon compound | 40-60 | wt. % |
| Filler | 5-35 | wt. % |
| Polymer Modifier | 0.05-35 | wt. % |
| Ground Tire Rubber | 0-10 | wt. % |
| Hydrocarbon Resin or Process Oil | 0-10 | wt. % |
| Antioxidant | 0-1 | wt. % |
| UV Stabilizer | 0-1 | wt. % |
| Wax | 0-3 | wt. % |
| Fire Retardant | 1-25 | wt. % |
| Fiber reinforcement | 0-40 | wt. %. |

17. The roofing and/or siding material as defined in claim 12, wherein said modified bitumen sheet/membrane comprises:

| | | |
|---|---|---|
| Primary hydrocarbon compound | 45-60 | wt. % |
| Filler | 7-35 | wt. % |
| Polymer Modifier | 0.05-35 | wt. % |
| Ground Tire Rubber | 0-8 | wt. % |
| (100-200 mesh average size) | | |
| Hydrocarbon Resin or Process Oil | 0.1-6 | wt. % |
| Antioxidant | 0.1-1 | wt. % |
| UV Stabilizer | 0.1-1 | wt. % |
| Wax | 0-3 | wt. % |
| Fire Retardant | 2-22 | wt. % |
| Fiber reinforcement | 0-40 | wt. %. |

18. The roofing and/or siding material as defined in claim 12, wherein said modified bitumen sheet/membrane comprises:

| | | |
|---|---|---|
| Primary hydrocarbon compound | 50-60 | wt. % |
| Filler | 20-30 | wt. % |
| Polymer Modifier | 10-30 | wt. % |
| Ground Tire Rubber | 0-8 | wt. % |
| (100-200 mesh average size) | | |
| Hydrocarbon Resin or Process Oil | 0.1-6 | wt. % |
| Antioxidant | 0.1-1 | wt. % |
| UV Stabilizer | 0.1-1 | wt. % |
| Wax | 0-3 | wt. % |
| Fire Retardant | 2-22 | wt. % |
| Fiber reinforcement | 0-40 | wt. %. |

19. A method for forming a roofing and/or siding material that has a resulting reflectivity of at least about 50%; said method comprises:
a. providing a modified bitumen sheet/membrane; said modified bitumen sheet/membrane is a bitumen membrane; said bitumen membrane includes a primary hydrocarbon compound and a primary hydrocarbon compound and one or more of a) filler; b) polymer modifier;
c) hydrocarbon resin or process oil; d) ground tire rubber; e) antioxidant; f) UV stabilizer; g) fire retardant; h) wax; i) reinforcement fibers; and j) tackifying agent;
b. providing a preformed reflective polymer layer material; said reflective polymer layer material includes one or more layers of polyvinyl fluoride; said preformed reflective polymer layer material has a thickness of 0.5-100 mils; and
c. securing said preformed reflective polymer layer material to a top surface of said modified bitumen sheet/membrane by use of an adhesive; and
wherein said preformed reflective polymer layer material forms at least a portion of said top surface of said roofing and/or siding material, and
wherein said preformed reflective polymer layer material has a thickness that is less than a thickness of said modified bitumen sheet/membrane.

20. The method as defined in claim 19, further including the steps of:
providing a fiber reinforcement layer; said fiber reinforcement layer includes polyester, polyethylene and/or fiberglass; and
partially or fully embedding said fiber reinforcement layer in said modified bitumen sheet/membrane.

21. The method as defined in claim 19, further including the steps of:
providing a removable release liner; said release liner; said release liner is formed of one or more of paper, a polymeric film, or paper that is coated with polymeric film; and
applying said removable release liner to a bottom surface of said bitumen roofing membrane.
